(19) United States
(12) Patent Application Publication
(10) Pub. No.: US 2004/0110048 A1
(43) Pub. Date: Jun. 10, 2004

(54) Fuel cell system

(75) Inventors: Hidehiko Hiramatsu, Kariya-shi (JP); Shingo Morishima, Toyota-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/721,183

(22) Filed: Nov. 26, 2003

(30) Foreign Application Priority Data
Dec. 9, 2002 (JP) 2002-356565

(51) Int. Cl. H01M 8/04

(52) U.S. Cl. 429/22; 429/34

(57) ABSTRACT

Under a condition that a main stream hydrogen amount fed into a fuel cell is constant, an off-gas circulation amount and a hydrogen concentration of the circulated off-gas are in a predetermined relationship. Considering this relationship, the hydrogen concentration of the circulated off-gas can be obtained by detecting the main stream hydrogen amount and the off-gas circulation amount. The impurities contained in the circulated off-gas are chiefly nitrogen. The nitrogen concentration of the circulated off-gas is inverse proportional to the hydrogen concentration. The nitrogen concentration (i.e., impurity concentration) is obtainable by detecting the hydrogen concentration. Increase of impurities contained in the circulated off-gas is detectable in advance based on the main stream hydrogen amount and the off-gas circulation amount. The impurities can be removed before the output of the fuel cell becomes unstable. The fuel cell operates stably.

### BACKGROUND OF THE INVENTION

This invention relates to a fuel cell system including a fuel cell which is capable of generating electric energy based on chemical reaction of hydrogen and oxygen. The fuel cell system of this invention is applicable to automotive vehicles, marine vessels, portable power generators, and other mobile devices.

To suppress reduction in fuel utilization rate as well as power generation efficiency of fuel cells, it is conventionally known to provide a pump apparatus for sucking the off-gas exhausted from the hydrogen electrode of the fuel cell and for mixing the off-gas with the fuel supplied into the fuel cell, thereby realizing a fuel cell system having an off-gas recirculation function for the fuel cell. The off-gas recirculation function of the pump apparatus is for example realized by an ejector pump which can utilize fluid energy of the supplied fuel and according can operate with least energy consumption.

It is also known that, due to air penetration via an electrolytic membrane of the fuel cell, impurities such as nitrogen deposit in the off-gas circulation path and accordingly the hydrogen concentration of the circulated off-gas reduces and also the output of the fuel cell reduces. Furthermore, in a case that the hydrogen amount fed into the fuel cell is insufficient, the hydrogen outlet side of the fuel cell will encounter with the shortage of fuel. Accordingly, the output of the fuel cell becomes unstable and the output density becomes non-uniform. This will induce deterioration of the electrolytic membrane.

In view of the foregoing problems, it is possible to detect an amount of impurities contained in the circulated off-gas based on the fuel cell output condition and remove the impurities when the fuel cell output is reduced to an undesirable level (refer to the Japanese Patent Application Laid-open No. 2000-243417).

However, according to the above-described conventional fuel cell system, the increase of impurities is undetectable until the fuel cell output is reduced to a predetermined level. There is a problem that the fuel cell output may be already in an unstable condition before or at the time the operation for removing the impurities is started.

### SUMMARY OF THE INVENTION

In view of the above-described problems of the prior art, the present invention has an object to provide a fuel cell system which is capable of assuring stable operations regardless of recirculation of the off-gas into the fuel cell.

In order to accomplish the above and other related objects, the present invention provides a fuel cell system including a fuel cell for generating electric energy based on electrochemical reaction of hydrogen and oxygen, a hydrogen supply apparatus for feeding hydrogen into the fuel cell, and a hydrogen supply path for introducing the hydrogen from the hydrogen supply apparatus into the fuel cell. An off-gas circulation path is provided for introducing an off-gas into the hydrogen supply path. The off-gas contains non-reacted hydrogen exhausted from the fuel cell without being consumed in the chemical reaction among the hydrogen fed into the fuel cell. An off-gas circulating means is provided for circulating the off-gas into the off-gas circulation path and also for mixing the off-gas with a main stream of hydrogen fed from the hydrogen supply apparatus. Furthermore, according to the fuel cell system of this invention, a main stream hydrogen amount detecting means is provided for detecting a hydrogen amount in the main stream of hydrogen. An off-gas circulation amount detecting means is provided for detecting a circulation amount of the off-gas. An impurity removing means is provided for removing impurities not contributing to the electrochemical reaction from the off-gas circulation path. An operation of the impurity removing means is controlled based on a hydrogen concentration in the off-gas circulation path. The hydrogen concentration in the off-gas circulation path is calculated based on the hydrogen amount in the main stream of hydrogen and the off-gas circulation amount.

The off-gas circulating means of this invention is, for example, realized by an ejector pump. FIG. 2 shows a relationship between an off-gas circulation amount and a pressure difference between a suction side and a discharge side of the ejector pump under a condition that the hydrogen amount in the main stream of hydrogen is constant. Furthermore, FIG. 3 shows a relationship between the off-gas circulation amount and a hydrogen concentration of the circulated off-gas under a condition that the hydrogen amount in the main stream of hydrogen is constant.

Considering these relationships, the hydrogen concentration of the circulated off-gas can be obtained by detecting the hydrogen amount in the main stream of hydrogen and the off-gas circulation amount. The impurities contained in the circulated off-gas are chiefly nitrogen. And, the nitrogen concentration of the circulated off-gas is inverse proportional to the hydrogen concentration. Thus, it is possible to detect the nitrogen concentration (i.e., impurity concentration) by detecting the hydrogen concentration.

Therefore, according to the present invention, it becomes possible to detect the increase of impurities contained in the circulated off-gas before the output of the fuel cell becomes unstable. The impurities can be removed in advance. The fuel cell can operate stably.

Preferably, the off-gas circulating means is an ejector pump. And, the main stream hydrogen amount detecting means calculates the hydrogen amount in the main stream of hydrogen based on a pressure of the hydrogen supply path at an upstream side of the ejector pump and a pressure at a discharge side of the ejector pump, as well as based on an opening area of a nozzle of the ejector pump. This arrangement makes it possible to detect the hydrogen amount in the main stream of hydrogen with a simple arrangement.

Preferably, the off-gas circulating means is an ejector pump which is disposed in the hydrogen supply path to suck and discharge the off-gas by utilizing entrainment function caused by the main stream of hydrogen ejected from the nozzle. And, the off-gas circulation amount detecting means calculates the circulation amount of the off-gas based on a pressure difference between a suction side and a discharge side of the ejector pump and also based on the hydrogen amount in the main stream of hydrogen.

Furthermore, it is preferable to calculate a hydrogen amount fed into the fuel cell based on the hydrogen concentration in the off-gas circulation path.

According to this arrangement, it is possible to obtain a sum of a hydrogen amount contained in the circulated off-gas obtained based on the hydrogen concentration of the circulated off-gas and a hydrogen amount in the main stream of hydrogen representing a flesh hydrogen amount. The sum of these hydrogen amounts being thus obtained is equal to the total hydrogen amount fed into the fuel cell.

Preferably, the operation of the impurity removing means is controlled in such a manner that the hydrogen amount fed into the fuel cell satisfies a predetermined condition.

It is conventionally known that the impurities can be removed by continuously exhausting a part of the circulated off-gas to the outside. However, in this case, continuously exhausting a part of the circulated off-gas to the outside is disadvantageous in that the hydrogen amount being wasted uselessly will increase. The fuel utilization rate will decrease accordingly. On the contrary, the above arrangement of the present invention makes it possible to suppress the reduction in the utilization rate and accordingly makes it possible to remove the impurities efficiently.

Preferably, the predetermined condition is a requested stoichiometric value which is a stoichiometric value obtained from a requested power generation amount, when the stoichiometric value is defined as a value equivalent to the hydrogen amount fed into the fuel cell divided by a hydrogen consumption amount obtained from a power generation amount of the fuel cell. This prevents the fuel cell from suffering with the lack of hydrogen.

Preferably, the predetermined condition is a requested hydrogen concentration obtained from a requested power generation amount. This prevents the fuel cell from suffering with the lack of hydrogen.

Preferably, the off-gas circulating means has a function of variably controlling the circulation amount of the off-gas. Furthermore, it is preferable to control the circulation amount of the off-gas based on a hydrogen concentration in the off-gas circulation path in such a manner that the hydrogen amount fed into the fuel cell satisfies a predetermined condition. This arrangement eliminates the shortage of hydrogen, stabilizes the operation of the fuel cell, and prevents the electrolytic membrane from deteriorating.

Preferably, the predetermined condition is a requested stoichiometric value which is a stoichiometric value obtained from a requested power generation amount, when the stoichiometric value is defined as a value equivalent to the hydrogen -amount fed into the fuel cell divided by a hydrogen consumption amount obtained from a power generation amount of the fuel cell. This prevents the fuel cell from suffering with the lack of hydrogen.

Preferably, the predetermined condition is a requested hydrogen concentration obtained from a requested power generation amount. This prevents the fuel cell from suffering with the lack of hydrogen.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a schematic diagram showing an overall arrangement of a fuel cell system in accordance with a first embodiment of the present invention;

FIG. 2 is a graph showing a relationship between an off-gas circulation flow amount Qe and a pressure difference ΔP between an ejector discharge pressure Pd and an ejector suction pressure Pe;

FIG. 3 is a graph showing a relationship between the off-gas circulation flow amount Qe and a hydrogen concentration of the circulated off-gas as well as a relationship between the hydrogen concentration of the circulated off-gas and a stoichiometric value;

FIG. 4 is a flowchart showing the processing executed in the control section of the fuel cell system in accordance with the first embodiment of the present invention;

FIG. 5 is a schematic diagram showing an overall arrangement of a fuel cell system in accordance with a second embodiment of the present invention; and

FIG. 6 is a flowchart showing the processing executed in the control section of the fuel cell system in accordance with the second embodiment of the present invention.

### DESCRIPTION OF THE PREFERRED EMBODIMENTS

Preferred embodiments of the present invention will be explained hereinafter with reference to attached drawings.

### First Embodiment

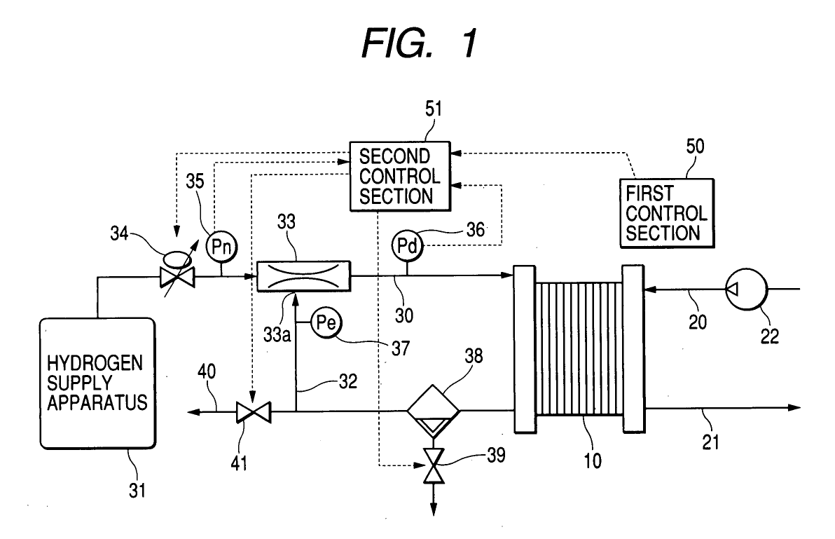

FIGS. 1 to 4 cooperatively show a fuel cell system in accordance with a first embodiment of the present invention. The fuel cell system according to the first embodiment is applicable to an electric automotive vehicle (i.e., a fuel cell vehicle) which installs a fuel cell serving as a power source for traveling.

FIG. 1 is a schematic diagram showing a fuel cell system in accordance with a first embodiment of the present invention. A fuel cell (i.e., FC stack) 10 generates electric power based on electrochemical reaction of hydrogen and oxygen. In this reaction, the hydrogen serves as fuel and the oxygen serves as oxidizing agent. According to the first embodiment of the present invention, the fuel cell 10 is a solid polymeric electrolyte type fuel cell including a plurality of cells arranged or stacked into a multilayered structure. Each cell is a fundamental unit of the fuel cell 10. Each cell includes an electrolytic membrane sandwiched between a pair of electrodes. The fuel cell 10, as an essential function, supplies electric power to various electric devices (not shown) including a traveling motor and a secondary cell. The fuel cell 10 receives hydrogen and air (oxygen) being fed from a storage apparatus or the outside, and generates electric energy based on the following electrochemical reaction of the hydrogen and the oxygen.

(Hydrogen electrode side) H₂→2H⁺+2e⁻

(Oxygen electrode side) 2H⁺+½O₂+2e⁻→H₂O

With this electrochemical reaction, water is produced. Wet hydrogen and air are supplied into the fuel cell 10. The fuel cell 10 condensates the water. Hence, the residual water is present in the fuel cell 10.

The fuel cell system includes an air supply path 20 for feeding the air (i.e., oxygen) into an oxygen electrode (i.e., positive electrode) side of the fuel cell 10, and an air exhaust path 21 for discharging the air together with the produced water from the fuel cell 10 to the outside. An air supply apparatus 22 is provided at an upstream side of the air supply path 20. According to the first embodiment, the air supply apparatus 22 is an air compressor.

The fuel cell system further includes a hydrogen supply path 30 for feeding hydrogen into a hydrogen electrode (i.e., negative electrode) side of the fuel cell 10, and a hydrogen supply apparatus 31 provided at an upstream end of the hydrogen supply path 30. According to the first embodiment, the hydrogen supply apparatus 31 is a high-pressure hydrogen tank which is filled with the hydrogen gas.

The fuel cell 10 discharges the off-gas which contains non-reacted hydrogen having not being consumed in the above-described electrochemical reaction. An off-gas circulation path 32 is provided for causing the off-gas to merge into the main stream of hydrogen flowing into the fuel cell 10 from the hydrogen supply apparatus 31. Thus, a part of the off-gas is again-fed or circulated into the fuel cell 10. The off-gas circulation path 32 connects an outlet side of the hydrogen electrode and the hydrogen supply path 30 of the fuel cell 10.

An ejector pump 33 is provided at a merging point of the hydrogen supply path 30 and the off-gas circulation path 32. The ejector pump 33 has a function of circulating the off-gas. The off-gas circulation path 32 is connected to a suction portion 33a of the ejector pump 33. The ejector pump 33 is a momentum-transport type pump (JIS Z 8126 No. 2.1.1.3) which performs fluid transportation based on entrainment function of operation fluid being ejected at high speeds. More specifically, the ejector pump 33 has a nozzle having a fixed opening area and has a function of sucking and circulating the off-gas by utilizing the fluid energy of a main stream of hydrogen fed from the hydrogen supply apparatus 31. The ejector pump 33 serves as off-gas circulating means of the present invention.

A regulator 34, intervening between the hydrogen supply apparatus 31 and the ejector pump 33 in the hydrogen supply path 30, adjusts the pressure of hydrogen fed from the hydrogen supply apparatus 31. A first pressure sensor 35, intervening between the regulator 34 and the ejector pump 33 in the hydrogen supply path 30, detects a pressure Pn of the main stream of hydrogen adjusted in the regulator 34 (hereinafter, referred to as main stream hydrogen pressure Pn). A second pressure sensor 36, intervening between the ejector pump 33 in the hydrogen supply path 30 and the fuel cell 10, detects a pressure Pd of a mixed stream of the main stream hydrogen and the circulated off-gas at a discharge side of the ejector pump 33 (hereinafter, referred to as ejector discharge pressure Pd).

A third pressure sensor 37, provided in the off-gas circulation path 32, detects the pressure Pe of the circulated off-gas at the suction side of the ejector pump 33 (hereinafter, referred to as ejector suction pressure Pe). A gas-liquid separator 38, intervening between the fuel cell 10 and the third pressure sensor 37 in the off-gas circulation path 32, separates and removes the water contained in the off-gas. The gas-liquid separator 38 includes a water drain valve 39 for discharging the water having been separated by the gas-liquid separator 38 to the outside.

Furthermore, to remove the off-gas containing the impurities not contributing to the electrochemical reaction out of the off-gas circulation path 32, an off-gas exhaust path 40 is provided between the gas-liquid separator 38 and the third pressure sensor 37 of the off-gas circulation path 32. Namely, the off-gas exhaust path 40 is branched from the off-gas circulation path 32 to discharge the off-gas to the outside. An off-gas exhaust path control valve 41, provided in the off-gas exhaust path 40, opens or closes the off-gas exhaust path 40. The off-gas exhaust path control valve 41 serves as impurity removing means of this invention.

The fuel cell system includes two, first and second, control sections (each being also referred to as Electronic Control Unit) 50 and 51. The first control section 50 receives sensor data, such as an accelerator opening degree detected by an accelerator opening degree sensor (not shown). The first control section 50 calculates a requested power generation amount for the fuel cell 10 based on the detected accelerator opening degree and others. Furthermore, the first control section 50 calculates a hydrogen supply amount Qc necessary for the fuel cell 10 to generate electric power designated by the requested power generation amount. The first control section 50 transmits a command signal based on the above calculations to the second control section 51.

The second control section 51 receives the command signal sent from the first control section 50 and sensor signals sent from the pressure sensors 35, 36, and 37. The second control section 51 calculates a valve opening degree of the regulator 34 based on the requested hydrogen supply amount Qc. The second control section 51 outputs a control signal to the regulator 34 based on the calculated valve opening degree. Furthermore, the second control section 51 outputs control signals to the water drain valve 39 and the off-gas exhaust path control valve 41. The second control section 51 serves as main stream hydrogen amount detecting means of this invention as well as off-gas circulation amount detecting means of this invention.

The impurities contained in the off-gas are chiefly nitrogen having penetrated an electrolytic membrane of the fuel cell 10. Circulation of the off-gas causes the impurities (i.e., nitrogen) to deposit in the off-gas circulation path 32. The nitrogen concentration of the circulated off-gas (i.e., impurity concentration) gradually increases. By the way, the nitrogen concentration of the circulated off-gas is inverse proportional to the hydrogen concentration. Accordingly, obtaining either one of the nitrogen concentration and the hydrogen concentration is equivalent to knowing the other.

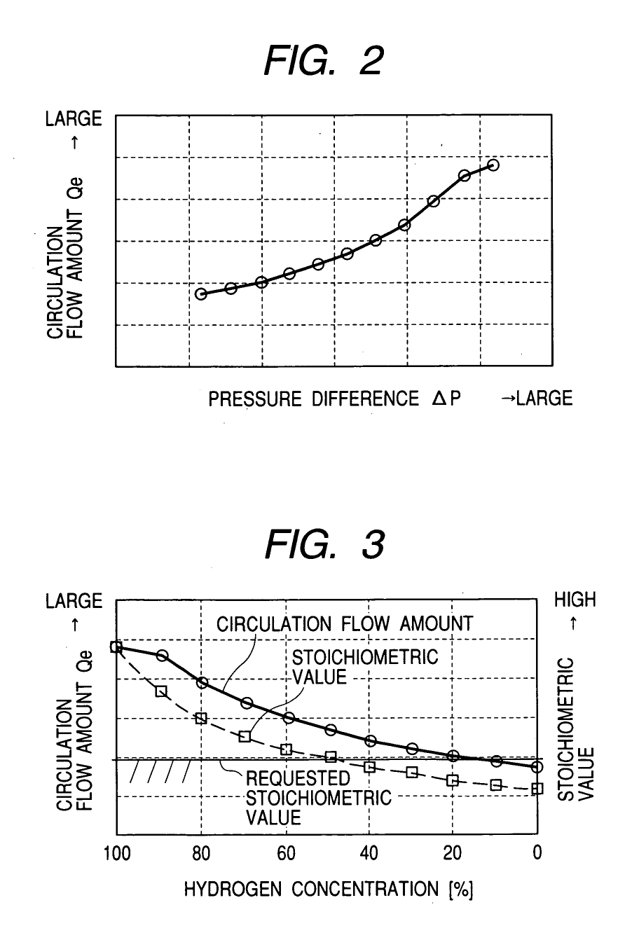

When the ejector pump 33 is used to circulate the off-gas under a condition that a main stream hydrogen amount Qn fed from the hydrogen supply apparatus 31 to the fuel cell 10 is constant, a pressure difference ΔP between the ejector discharge pressure Pd and the ejector suction pressure Pe, i.e., ΔP=Pd−Pe, and an off-gas circulation flow amount Qe are in a predetermined relationship shown in FIG. 2, according to which the off-gas circulation flow amount Qe increases with increasing pressure difference ΔP. Practical values of the pressure difference ΔP and the off-gas circulation flow amount Qe change depending on the main stream hydrogen amount Qn.

FIG. 3 shows a relationship between the off-gas circulation flow amount Qe and a hydrogen concentration of the circulated off-gas as well as a relationship between the hydrogen concentration of the circulated off-gas and a stoichiometric value, under the condition that main stream hydrogen amount Qn is constant. In this specification, the stoichiometric value is defined as a value equivalent to a total hydrogen amount fed into the fuel cell 10 (i.e., a sum of the main stream hydrogen amount and the hydrogen amount contained in the circulation gas) divided by a hydrogen consumption amount obtained from the power generation amount of the fuel cell 10. A requested stoichiometric value is a stoichiometric value obtained from the requested power generation amount. Furthermore, in an ordinary condition, the hydrogen consumption amount is almost equal to the main stream hydrogen amount. As shown in FIG. 3, the hydrogen concentration of the circulated off-gas decreases with decreasing circulation flow amount Qe. The stoichiometric value decreases with decreasing hydrogen concentration of the circulated off-gas.

Considering the above-described relationships, either the hydrogen concentration or the nitrogen concentration of the circulated off-gas can be known by detecting the main stream hydrogen amount Qn and the off-gas circulation flow amount Qe. The stoichiometric value is also known. Accordingly, as explained later, increase of the impurities contained in the circulated off-gas is detectable in advance and the impurities can be removed before the output of the fuel cell 10 becomes unstable. Thus, the fuel cell 10 can operate stably.

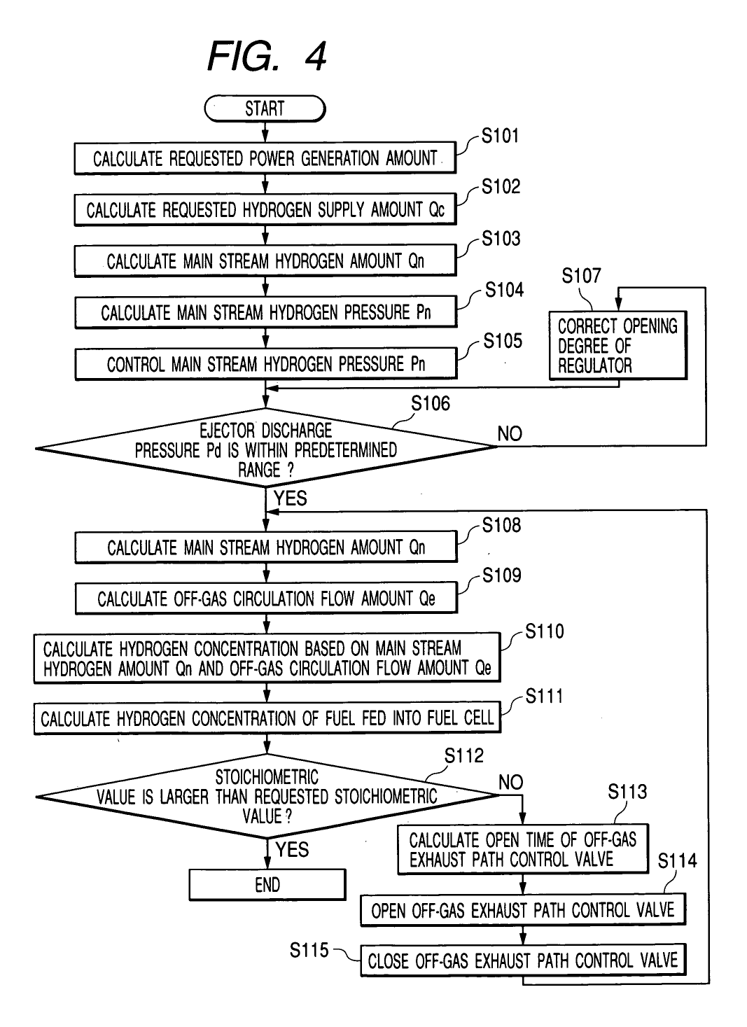

FIG. 4 is a flowchart showing the operation of the above-described fuel cell system. The operation shown in FIG. 4 is executed by the above-described control sections 50 and 51.

First of all, the first control section 50 calculates the requested power generation amount for the fuel cell 10 based on the accelerator opening degree and others (refer to step S101). Then, the first control section 50 calculates the requested hydrogen supply amount Qc based on the requested power generation amount (refer to step S102).

Next, the second control section 51 calculates a target value of the main stream hydrogen amount Qn based on the requested hydrogen supply amount Qc (refer to step S103). Furthermore, the second control section 51 calculates the main stream hydrogen pressure Pn required for equalizing an actual main stream hydrogen amount Qn with the target amount obtained in the step S103 (refer to step S104). Then, the second control section 51 controls the regulator 34 in such a manner that an actual main stream hydrogen pressure Pn is equalized with the target pressure calculated in the step S104 (refer to step S105).

Next, the second control section 51 makes a judgment as to whether or not the ejector discharge pressure Pd is within a predetermined range obtained based on the power generation amount of the fuel cell 10 and others (refer to step S106). When the ejector discharge pressure Pd is out of the predetermined range (i.e., NO in step S106), the second control section 51 corrects the opening degree of the regulator 34 to adjust the ejector discharge pressure Pd (refer to step S107).

On the other hand, when the ejector discharge pressure Pd is within the predetermined range (i.e., YES in step S106), the second control section 51 calculates the main stream hydrogen amount Qn (refer to step S108). More specifically, the second control section 51 calculates the main stream hydrogen amount Qn based on the main stream hydrogen pressure Pn, the ejector discharge pressure Pd, and the nozzle opening area of ejector pump 33.

Next, the second control section 51 calculates the off-gas circulation flow amount Qe based on the pressure difference ΔP between the ejector discharge pressure Pd and the ejector suction pressure Pe and also based on the main stream hydrogen amount Qn obtained in the step S108 (refer to step S109). More specifically, the second control section 51 obtains the off-gas circulation flow amount Qe with reference to a three-dimensional map defining the correlation among the main stream hydrogen amount Qn, the pressure difference ΔP, and the off-gas circulation flow amount Qe.

Next, the second control section 51 calculates the hydrogen concentration of the circulated off-gas based on the main stream hydrogen amount Qn obtained in the step S108 and the off-gas circulation flow amount Qe obtained in the step S109 (refer to step S110). More specifically, the second control section 51 obtains the hydrogen concentration of the circulated off-gas with reference to a three-dimensional map defining the correlation among the main stream hydrogen amount Qn, the off-gas circulation flow amount Qe, and the hydrogen concentration of the circulated off-gas.

Next, the second control section 51 calculates a present hydrogen concentration of the fuel being currently fed into the fuel cell 10 based on the main stream hydrogen amount Qn obtained in the step S108 and the hydrogen concentration of the circulated off-gas obtained in the step S109 (refer to step S111).

Next, the second control section 51 makes a judgment as to whether or not the stoichiometric value is larger than the requested stoichiometric value (refer to step S112). More specifically, the second control section 51 calculates a hydrogen amount Qh contained in the circulated off-gas based on the hydrogen concentration obtained in the step S111. Then, the second control section 51 calculates the stoichiometric value, i.e., (Qn+Qh)/Qn. When the stoichiometric value is less than the requested stoichiometric value (i.e., NO in S112), the second control section 51 calculates an open time t of the off-gas exhaust path control valve 41 with reference to a map defining a predetermined relationship between the hydrogen concentration of the circulated off-gas and the open time t of the off-gas exhaust path control valve 41 (refer to step S113). Then, the second control section 51 opens the off-gas exhaust path control valve 41 for the duration designated by the open time t and then closes the off-gas exhaust path control valve 41 (refer to steps S114 and S115).

Under the condition that the off-gas exhaust path control valve 41 opens the off-gas exhaust path 40, the impurities contained in the circulated off-gas are exhausted to the outside. In other words, the hydrogen concentration of the circulated off-gas increases and accordingly the stoichiometric value increases. In this manner, satisfying the requested stoichiometric value during the supply of hydrogen into the fuel cell 10 makes it possible to assure stable operation of the fuel cell 10. After accomplishing the step S115, the control flow returns to the step S108 to execute the administration of the stoichiometric value repetitively.

According to the above-described first embodiment, increase of the impurities contained in the circulated off-gas is detectable in advance and the impurities can be surely removed before the output of the fuel cell 10 becomes unstable. Thus, the first embodiment of the present invention can assure stable operations of the fuel cell 10.

Furthermore, only when the stoichiometric value cannot satisfy the requested stoichiometric value due to increase of the impurities in the circulated off-gas, a part of the circulated off-gas is exhausted to the outside. In other words, the operation for discharging a part of the circulated off-gas to the outside is not always carried out. This makes it possible to reduce the hydrogen amount being wasted uselessly, and accordingly prevents the fuel utilization rate from reducing.

Furthermore, according to the above-described first embodiment, the off-gas circulation amount is controlled so as to satisfy the requested stoichiometric value. This is effective in eliminating the shortage of hydrogen and causing the fuel cell 10 to operate stably. As a result, it becomes possible to prevent the electrolytic membrane from deteriorating.

### Second Embodiment

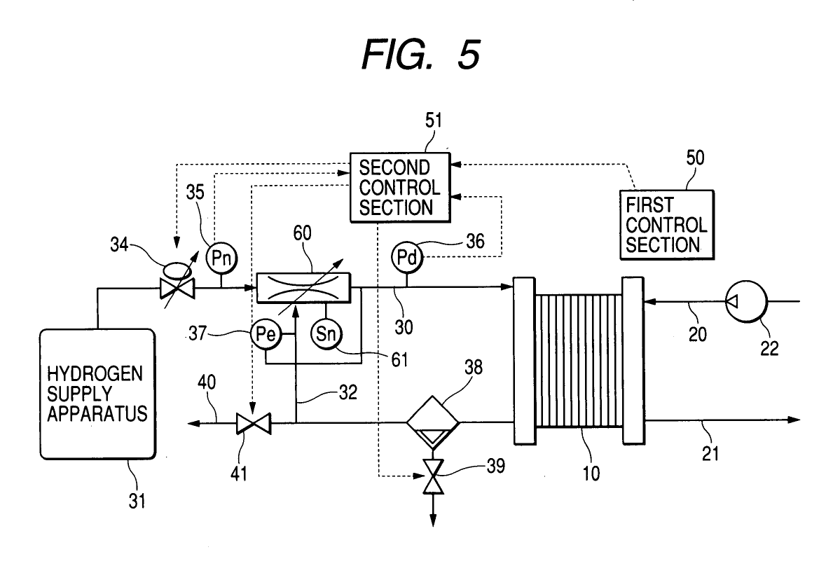

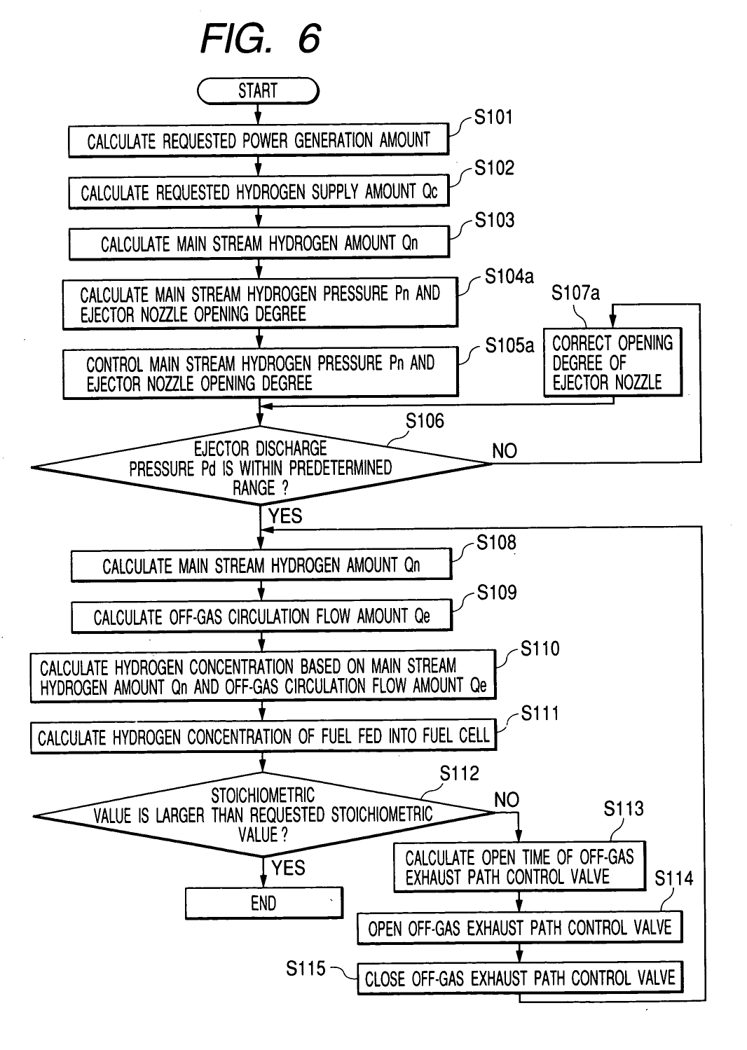

FIGS. 5 and 6 cooperatively show a fuel cell system in accordance with a second embodiment of the present invention. Although the above-described first embodiment uses the ejector pump 33 having a fixed nozzle opening area, the second embodiment employs an ejector pump 60 having a variable nozzle opening area. Although the first embodiment uses the third pressure sensor 37 for detecting the ejector suction pressure Pe, the second embodiment uses the third pressure sensor 37 for detecting a pressure difference ΔP between the ejector discharge pressure Pd and the ejector suction pressure Pe. The portions or components identical with or equivalent to those disclosed in the above-described first embodiment are denoted by the same reference numerals and explanation for them will be omitted hereinafter. Only the portions or components exclusively provided for the second embodiment will be explained, hereinafter.

In the fuel cell system shown in FIG. 5, the ejector pump 60 is equipped with a movable needle (not shown) which is capable of adjusting the nozzle opening area (i.e., nozzle opening degree). Thus, the nozzle opening degree is arbitrary changed or variably controlled by shifting the movable needle. Furthermore, the ejector pump 60 is equipped with a nozzle opening degree sensor 61 which detects the nozzle opening degree.

FIG. 6 is a flowchart showing the operation of the fuel cell system in accordance with the second embodiment of the present invention.

After the target value of main stream hydrogen amount Qn is calculated in the step S103, the second control section 51 calculates the target main stream hydrogen pressure Pn required for equalizing the actual main stream hydrogen amount Qn with the target amount obtained in the step S103 and also obtains a target nozzle opening degree of the ejector pump 60 (refer to step S104a). Then, the second control section 51 controls the regulator 34 in such a manner that the actual main stream hydrogen pressure Pn is equalized with the target pressure calculated in the step S104a and also controls the ejector pump 60 in such a manner that the actual nozzle opening degree is equalized with the target opening degree obtained in the step S104a (refer to step S105a).

Next, when the ejector discharge pressure Pd is out of the predetermined range (i.e., NO in S106), the second control section 51 corrects the nozzle opening degree of the ejector pump 60 to adjust the ejector discharge pressure Pd so that the ejector discharge pressure Pd is somewhere within the predetermined range (refer to step S107a).

Although the processing of step S110 is performed to calculate the hydrogen concentration of the circulated off-gas like the first embodiment, this embodiment calculates the hydrogen concentration of the circulated off-gas with reference to a map defining the relationship among the main stream hydrogen amount Qn and the off-gas circulation flow amount Qe relative to the nozzle opening degree and the hydrogen concentration of the circulated off-gas.

Thus, the second embodiment brings substantially the same effects as those of the first embodiment and therefore realizes accurate control of hydrogen supply pressure.

### Other Embodiment

According to the above-described embodiments, the second control section 51 calculates the open time t of the off-gas exhaust path control valve 41 in the step S113 and opens the off-gas exhaust path control valve 41 for the duration designated by the calculated open time t. However, it is possible to omit the step S113 and instead open the off-gas exhaust path control valve 41 for a predetermined time (e.g., 100 ms) in the step S114.

Furthermore, according to the above-described embodiments, the second control section 51 calculates the main stream hydrogen amount Qn and the off-gas circulation flow amount Qe based on the pressure data detected by various pressure sensors 35, 36, and 37. However, it is possible to replace the pressure sensors 35, 36, and 37 with flow meters and directly detect the main stream hydrogen amount Qn and the off-gas circulation flow amount Qe based on flow amount data detected by these flow meters.

What is claimed is:

1. A fuel cell system comprising:
a fuel cell for generating electric energy based on electrochemical reaction of hydrogen and oxygen;
a hydrogen supply apparatus for feeding hydrogen into said fuel cell;
a hydrogen supply path for introducing the hydrogen from said hydrogen supply apparatus into said fuel cell;
an off-gas circulation path for introducing an off-gas into said hydrogen supply path, said off-gas containing non-reacted hydrogen exhausted from said fuel cell without being consumed in said chemical reaction among the hydrogen fed into said fuel cell;
off-gas circulating means for circulating said off-gas into said off-gas circulation path and also for mixing said off-gas with a main stream of hydrogen fed from said hydrogen supply apparatus;
main stream hydrogen amount detecting means for detecting a hydrogen amount in said main stream of hydrogen;
off-gas circulation amount detecting means for detecting a circulation amount of said off-gas; and
impurity removing means for removing impurities not contributing to the electrochemical reaction from said off-gas circulation path,
wherein an operation of said impurity removing means is controlled based on a hydrogen concentration in said off-gas circulation path, and
the hydrogen concentration in said off-gas circulation path is calculated based on the hydrogen amount in said main stream of hydrogen and the circulation amount of said off-gas.

2. The fuel cell system in accordance with claim 1, wherein
said off-gas circulating means is an ejector pump, and
said main stream hydrogen amount detecting means calculates the hydrogen amount in said main stream of hydrogen based on a pressure of said hydrogen supply path at an upstream side of said ejector pump and a pressure at a discharge side of said ejector pump, as well as based on an opening area of a nozzle of said ejector pump.

3. The fuel cell system in accordance with claim 1, wherein
said off-gas circulating means is an ejector pump with a nozzle which is disposed in said hydrogen supply path to suck and discharge said off-gas by utilizing entrainment function caused by said main stream of hydrogen ejected from said nozzle, and
said off-gas circulation amount detecting means calculates the circulation amount of said off-gas based on a pressure difference between a suction side and a discharge side of said ejector pump and also based on the hydrogen amount in said main stream of hydrogen.

4. The fuel cell system in accordance with claim 1, wherein a hydrogen amount fed into said fuel cell is calculated based on the hydrogen concentration in said off-gas circulation path.

5. The fuel cell system in accordance with claim 1, wherein the operation of said impurity removing means is controlled in such a manner that the hydrogen amount fed into said fuel cell satisfies a predetermined condition.

6. The fuel cell system in accordance with claim 5, wherein said predetermined condition is a requested stoichiometric value which is a stoichiometric value obtained from a requested power generation amount, when the stoichiometric value is defined as a value equivalent to the hydrogen amount fed into said fuel cell divided by a hydrogen consumption amount obtained from a power generation amount of said fuel cell.

7. The fuel cell system in accordance with claim 5, wherein said predetermined condition is a requested hydrogen concentration obtained from a requested power generation amount.

8. The fuel cell system in accordance with claim 1, wherein said off-gas circulating means has a function of variably controlling the circulation amount of said off-gas.

9. The fuel cell system in accordance with claim 8, wherein the circulation amount of said off-gas is controlled based on a hydrogen concentration in said off-gas circulation path in such a manner that the hydrogen amount fed into said fuel cell satisfies a predetermined condition.

10. The fuel cell system in accordance with claim 9, wherein said predetermined condition is a requested stoichiometric value which is a stoichiometric value obtained from a requested power generation amount, when the stoichiometric value is defined as a value equivalent to the hydrogen amount fed into said fuel cell divided by a hydrogen consumption amount obtained from a power generation amount of said fuel cell.

11. The fuel cell system in accordance with claim 9, wherein said predetermined condition is a requested hydrogen concentration obtained from a requested power generation amount.
